(19) United States
(12) Patent Application Publication
(10) Pub. No.: US 2025/0247429 A1
(43) Pub. Date: Jul. 31, 2025

(54) COMMAND VALIDATION AT AN INTERMEDIARY DEVICE

(71) Applicant: HEWLETT PACKARD ENTERPRISE DEVELOPMENT LP, Spring, TX (US)

(72) Inventors: Bryan Elliot Lechner, Richfield, MN (US); Mathew George, San Jose, CA (US)

(21) Appl. No.: 18/425,297

(22) Filed: Jan. 29, 2024

(51) Int. Cl. H04L 9/40

(52) U.S. Cl. CPC H04L 63/20; H04L 63/0435; H04L 63/166

(57) ABSTRACT

In some examples, an intermediary device receives, from a client device, a command associated with a secure protocol that secures a connection between the client device and a server system, where the intermediary device includes an inline authentication and authorization service between the client device and the server system. The authentication and authorization service at the intermediary device determines, based on command enforcement policy information, whether to authorize the command received from the client device.

### BACKGROUND

Client devices are able to access services provided by server systems. An example of a server system is a network access device (NAD) that a client device can connect to for accessing a network. Other examples of server systems include server systems that provide programs (e.g., web programs, application programs, or other programs) useable by client devices, resources (e.g., processing resources, storage resources, communication resources, or other resources) accessible by client devices on demand, or other types of server systems with functionalities that can be used by client devices.

### BRIEF DESCRIPTION OF THE DRAWINGS

Some implementations of the present disclosure are described with respect to the following figures.

FIG. 1 is a block diagram of an arrangement that includes a client device, an intermediary device, and a server system, according to some examples.

FIG. 2 is a message flow diagram of a process involving the client device, the intermediary device, the server system, according to some examples.

FIG. 3 is a block diagram of a storage medium storing machine-readable instructions according to some examples.

FIG. 4 is a block diagram of an intermediary device according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

An enterprise (e.g., a business concern, a government agency, an educational organization, an individual user or group of users, or any other entity) can employ security mechanisms to control access to services. For example, a zero trust network access (ZTNA) arrangement may be employed to securely provide access to the services according to specific access control policies. With ZTNA or any other access control mechanism, authentication of a client device occurs before the client device can be permitted access to services. A ZTNA arrangement includes an authentication and authorization system to authenticate client devices and to authorize activities of the client devices. The authentication and authorization system may operate according to an Authentication, Authorization, and Accounting (AAA) protocol, such as the Terminal Access Controller Access-Control System Plus (TACACS+) protocol. Another AAA protocol is the Remote Authentication Dial-In User Service (RADIUS) protocol.

Typically, a client device connects to a server system to obtain services of the server system, and the server system in turn contacts an authentication and authorization system to authenticate the client device. In such an arrangement, the server system is a client of the authentication and authorization system. For example, if the authentication and authorization system is a TACACS+ system, then the server system is a TACACS+ client of the TACACS+ system.

The client device may further send commands to the server system. The TACACS+ protocol, as described in Request for Comments (RFC) 8907, entitled “The Terminal Access Controller Access-Control System Plus (TACACS+) Protocol,” dated September 2020, provides the ability to restrict command execution based on user authorization. This is typically used when administrators (using client devices) are connecting to server systems to modify configurations of a server system. With traditional TACACS+ access, the server system has to use an external access control system to obtain authorizations on each command that the client device is attempting to execute. For example, in response to the commands, the server system may contact an authentication and authorization system to determine whether the commands received from the client device are authorized. If a command is authorized by the authentication and authorization system, the server system can execute the command. If a command is not authorized by the authentication and authorization system, then the server system can reject the command from the client device.

There may be many client devices that connect to the server system. In an arrangement that includes multiple server systems, a large quantity of requests (for authentication and authorization purposes) may be received by the authentication and authorization system from the server systems. As a result, the authentication and authorization system may have to be configured with sufficient computing power to handle the potentially large quantity of requests from the server systems. Such a heavyweight (in terms of provisioned resources) authentication and authorization system when deployed in an enterprise's premises may be expensive for the enterprise (e.g., due to increased equipment and software cost, increased maintenance cost, and other costs). Also, the large quantity of requests can cause a large number of interactions between each server system and the authentication and authorization system, which consumes processing and communication resources of the server system. As a result, the server system may become overburdened with authentication and authorization activities performed for client devices, which can reduce the capacity of the server system to perform its target services.

In accordance with some implementations of the present disclosure, an intermediary device including an inline authentication and authorization engine is provided between a client device and a server system. The authentication and authorization engine is “inline” between the client device and the server system in the sense that requests associated with authentication and authorization activities from the client device are first received at the authentication and authorization engine so that the authentication and authorization engine can perform the authentication and authorization activities for the client device, and the requests do not reach the server system. As a result, the server system that is to provide various target services for the client device does not have to contact a remote authentication and authorization system to authorize activities of the client device.

Further, in some examples, the intermediary device including the inline authentication and authorization engine may be provided in a cloud computing environment. Requests associated with authentication and authorization activities from client devices can be routed over a network such as the Internet to the intermediary device in the cloud computing environment. A benefit of implementing the intermediary device in the cloud computing environment is that additional resources (including processing resources, communication resources, and storage resources) can be provided for the intermediary device on demand as the quantity of requests to be processed by the intermediary device increases. With the intermediary device in the cloud computing environment, an enterprise would not have to deploy a costly authentication and authorization system at the enterprise's premises. Instead, the enterprise can pay for usage of resources for the intermediary device on demand as the resources are allocated by a cloud computing provider.

Although reference is made to an intermediary device with an inline authentication and authorization engine in in a cloud computing environment, it is noted that the intermediary device can be implemented in a different computing environment in other examples, such as in a data center or another computing environment.

In addition to authenticating client devices, the inline authentication and authorization engine is also able to authorize commands issued by client devices, where the commands are targeted to a server system and causes certain actions to be initiated at the server system. In response to a command from a client device, the inline authentication and authorization engine identifies a command enforcement policy based on information of the client device, and the inline authentication and authorization engine determines, based on the command enforcement policy, whether to authorize the command.

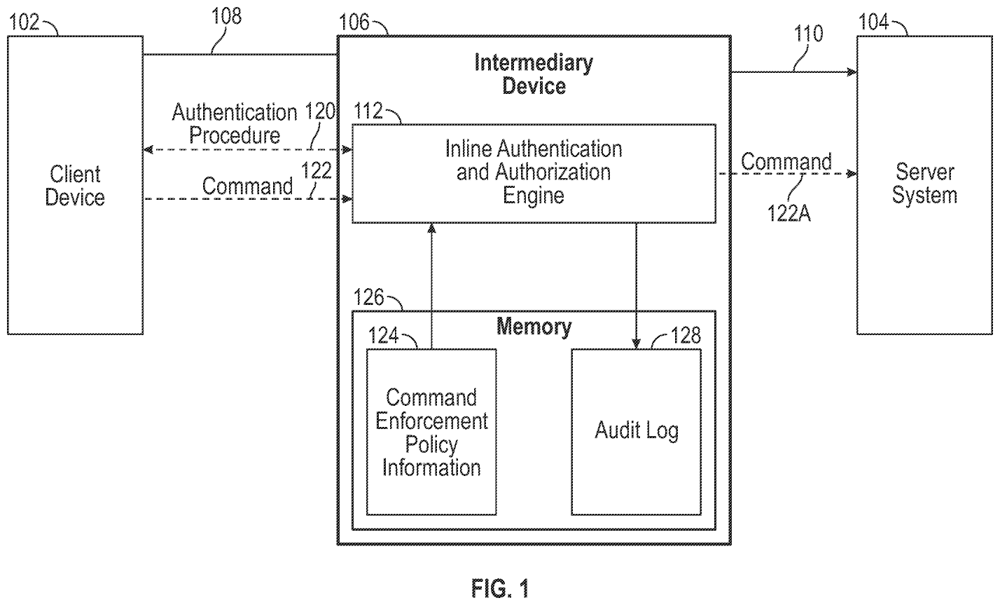

FIG. 1 is a block diagram of an example arrangement that includes a client device 102, a server system 104, and an intermediary device 106 between the client device 102 and the server system 104. Although FIG. 1 shows one client device 102 and one server system 104, in other examples, the intermediary device 106 may be connected between multiple client devices and multiple server systems. Also, there may be more than one intermediary device in further examples.

A “client device” can refer to any electronic device that is able to access services of the server system 104. Examples of electronic devices can include any or some combination of the following: a computer (e.g., a desktop computer, a server computer, a notebook computer, a tablet computer, or another type of computer), a smartphone, an Internet of Things (IOT) device, a household appliance, a game appliance, a vehicle, or any other type of electronic device.

The server system 104 can be implemented using one or more computers. Examples of server systems can include any or some combination of the following: a network access device that provides access to a network, a web server that provides web-based services, a cloud server that provides cloud-based services, a storage system, or any other type of system that has services accessible by client devices. Services offered by the server system 104 can include any or some combination of the following: a network access service that provides access to a network, a web service, an application program, usage of resources (e.g., processing resources, storage resources, communication resources, or other resources), or other types of functionalities. In examples where the server system 104 is a network access device, the server system 104 may include a switch, a router, a gateway, or any other device that enables access by client devices to a network. As discussed further below, in some examples, commands issued by the client device 102 (e.g., by a network administrator at the client device 102) relating to administrative tasks to be performed with respect to the server system 104, can be authorized by the intermediary device 106.

The intermediary device 106 can be implemented using one or more computers. The intermediary device 106 is connected over a communication link 108 with the client device 102, and the intermediary device 106 is connected over a communication link 110 with the server system 104. A “communication link” can refer to any type of communication medium that allows electronic devices to communicate with one another. Examples of communication links can include wireless links or wired links, including links that are part of networks.

As depicted in FIG. 1, for authentication and authorization purposes, the client device 102 does not connect directly to the server system 104. A client device is “directly connected” to a server system if the client device is able to communicate authentication and authorization (AA)-related messages with the server system and the AA-related message are to be handled by the server system. An “AA-related message” refers to any message that triggers an authentication task or an authorization task. A “message” can refer to a packet, an information element within a packet, or any other unit of information. In FIG. 1, the intermediary device 106 handles an AA-related messages from the client device 102, so that the server system 104 does not have to handle the AA-related messages. Effectively, the intermediary device 106 behaves as a server to the client device 102, and the intermediary device 106 behaves as a client to the server system 104.

In accordance with some implementations of the present disclosure, the intermediary device 106 includes an inline authentication and authorization engine 112 that is able to perform authentication and authorization tasks (e.g., ZTNA authentication and authorization tasks) for client devices, including the client device 102. As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

As depicted in FIG. 1, an authentication procedure 120 can be performed between the client device 102 and the inline authentication and authorization engine 112 to allow the intermediary device 106 to authenticate the client device 102. The client device 102 can also send a command (122) to the inline authentication and authorization engine 112. The inline authentication and authorization engine 112 can determine whether the command 122 is authorized. In some examples, the inline authentication and authorization engine 112 can authorized the command 122 based on command enforcement policy information 124 stored in a memory 126 of the intermediary device 106.

A memory can be implemented using one or more memory devices. Examples of memory devices include any or some combination of the following: a dynamic random access memory (DRAM) device, a static random access memory (SRAM) device, a flash memory device, or any other type of memory device. Although FIG. 1 shows an example in which the command enforcement policy information 124 is stored in the memory 126 that is part of the intermediary device 106, in other examples, the command enforcement policy information 124 (or a portion thereof) may be stored on an external storage that is outside the intermediary device 106.

The command enforcement policy information 124 may be in the form of one or more files (or in one or more other data structures). The command enforcement policy information 124 can include entries specifying conditions which respective commands are allowed (or not allowed). In other words, a given command is authorized (or rejected) if the condition(s) associated with the given command as specified in the command enforcement policy information 124 is (are) satisfied.

Although some examples of entries of the command enforcement policy information 124 are listed above, in other examples, other entries may specify conditions for other commands.

In some examples, the inline authentication and authorization engine 112 is able to authorize commands using the command enforcement policy information 124 without having to use dictionaries, such as TACACS+ dictionaries, provided at server systems. A TACACS+ dictionary provides a translation of a response from an authentication and authorization system to device-specific information for a given server system. Removing the dictionary allows for more precise and flexible definitions of the command enforcement policy information 124 without requiring the knowledge of the correct translation being applied for the actual server system.

If the inline authentication and authorization engine 112 is unable to authorize the command 122 according to the command enforcement policy information 124, then the inline authentication and authorization engine 112 prevents the execution of the command 122, by blocking the command 122 from being sent to the server system 104. The inline authentication and authorization engine 112 can drop the command 122, and may send an indication (e.g., an error indication, a reject indication, etc.) to the client device 102 that the command 122 is not authorized.

If the inline authentication and authorization engine 112 is able to authorize the command 122 according to the command enforcement policy information 124, then the inline authentication and authorization engine 112 allows the intermediary device 106 to forward the command 122 to the server system 104 (the forwarded command is represented as 122A). The server system 104 can execute the command 122A received from the intermediary device 106 to perform task(s) requested by the command 122A.

In some examples, the command 122A may be an administrative command or any other type of command that causes the server system 104 to perform a task. For example, administrative commands can include an enable command to enable a feature (e.g., a program, an electronic component, a functionality, etc.) of the server system 104. Another administrative command can be a command to disable a feature of the server system 104, or a command to shut down the server system 104. Another administrative command can be a command to turn on or off a port of the server system 104, such as a port of a network access device that is included in the server system 104. Another administrative command can be a command to allow a user or a client device to log into the server system 104.

Commands from the client device 102 may be according to a secure protocol such as a Secure Shell (SSH) protocol or another protocol. The SSH protocol provides a secure way to issue remote commands, such as the example commands noted above. A “secure protocol” refers to any protocol that secures communications between devices, such as between a client device and a server system.

Although some example commands are listed above, it is noted that there can be numerous other commands that can be issued by the client device 102 to the server system 104. Any such commands may be authorized by the inline authentication and authorization engine 112 according to the command enforcement policy information 124.

Examples of entries of the command enforcement policy information 124 are listed below. A first entry may specify that a “show run” command (which is to cause the server system 104 to show a configuration of the server system 104) is authorized under the following conditions: a client device that issued the command is owned or managed by a given enterprise and a malware protection program in the client device is up to date. A second entry may specify that an “enable” command (which enables a feature of the server system 104) is authorized under the following conditions: a client device that issued the command is owned or managed by a given enterprise and a malware protection program in the client device is up to date. A third entry may specify that any administrative command is disallowed if a malware protection program in the client device is out of date. A fourth entry may specify that any commands are disallowed if the client device is not owned by the enterprise. A fifth entry may specify that a command is allowed if a rate of incoming commands from the client device does not exceed a rate threshold (e.g., threshold number of commands per unit time). A sixth entry may specify that a command is allowed if the client device has not connected to more than a threshold quantity of server systems.

In some examples, communications between the client device 102 and the intermediary device 106 are encrypted in a first session established between the client device 102 and the intermediary device 106, and communications between the intermediary device 106 and the server system 104 are encrypted in a second session established between the intermediary device 106 and the server system 104. In some examples, the encryption of messages may be according to SSH encryption. In other examples, messages may be encrypted according to other secure protocols.

The first session can be established between the client device 102 and the intermediary device 106 based on exchanging credentials or keys between the client device 102 and the intermediary device 106. Similarly, the second session can be established between the intermediary device 106 and the server system 104 based on exchanging credentials or keys between the intermediary device 106 and the server system 104.

As an example, the client device 102 may send an encrypted message to the intermediary device 106 in the first session. The encrypted message may relate to the authentication procedure 120 or may include the command 122. The inline authentication and authorization engine 112 can decrypt the encrypted message to derive a decrypted message, and perform an authentication or authorization task according to the decrypted message. If the inline authentication and authorization engine 112 is to forward an authorized command to the server system 104, the inline authentication and authorization engine 112 encrypts the command and sends the encrypted command to the server system 104 in the second session.

The encryption of messages between the intermediary device 106 and each of the client device 102 and the server system 104 protects the messages against unauthorized access by attackers.

In other examples, communications between the client device 102 and the intermediary device 106, and communications between the intermediary device 106 and the server system 104, are not encrypted.

For each command processed by the inline authentication and authorization engine 112, the inline authentication and authorization engine 112 can add an entry regarding the processed command to an audit log 128, which can be stored in the memory 126. An “audit log” can refer to any data structure that is to store information pertaining to events, including processed commands, that have occurred in the intermediary device 106. In some examples where the memory 126 is a persistent memory, the audit log 128 is persistently stored (i.e., the audit log 128 is maintained stored in the memory 126 even if power is removed form the memory 126 or the intermediary device 106).

In response to processing a given command, the inline authentication and authorization engine 112 adds a respective entry to the audit log 128, where the respective entry can indicate whether the given command was authorized. Different entries are added to the audit log 128 for corresponding commands processed by the inline authentication and authorization engine 112. The audit log 128 can be reviewed by an entity (e.g., a human, a program, or a machine) to determine what commands were processed and the results of processing the commands.

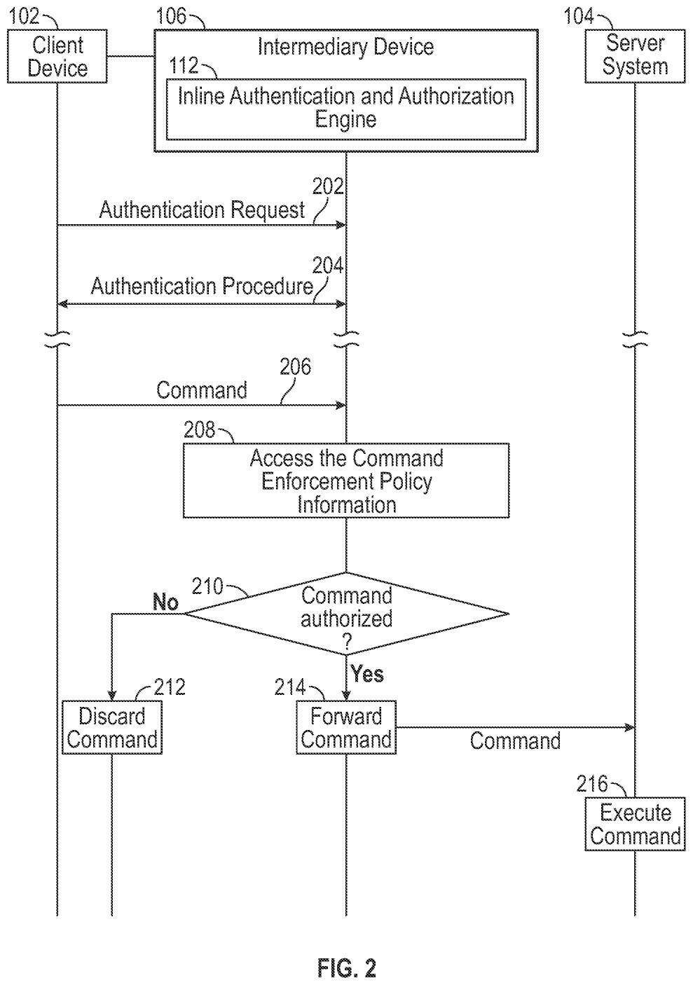

FIG. 2 is a message flow diagram of a process that involves the client device 102, the intermediary device 106, and the server system 104. To perform authentication, the client device 102 can send (at 202) an authentication request to the inline authentication and authorization engine 112 in the intermediary device 106. Note that the client device 102 is able to access the server system 104 after the client device 102 is authenticated. If the client device 102 is not authenticated, the client device 102 would not be able to access the server system 104.

In response to the authentication request 202, an authentication procedure is performed (at 204) between the client device 102 and the inline authentication and authorization engine 112. Assuming that the client device 102 has been authenticated by the inline authentication and authorization engine 112, the client device 102 is able to send commands to be executed by the server system 104. The commands that are sent can include SSH commands to perform administrative tasks, or other commands according to other protocols, whether standardized protocols, open-source protocols, or proprietary protocols.

The client device 102 sends (at 206) a command that is intercepted by the intermediary device 106. As noted above, the command may be an administrative command or another type of command. In response to the command, the inline authentication and authorization engine 112 accesses (at 208) the command enforcement policy information 124 to determine if any entry exists in the command enforcement policy information 124 for the command. The inline authentication and authorization engine 112 determines (at 210) whether the command is authorized. The command is not authorized by the inline authentication and authorization engine 112 if the command enforcement policy information 124 does not contain any entry for the command. If an entry exists in the command enforcement policy information 124 for the command, the inline authentication and authorization engine 112 determines whether the condition(s) for the command specified in the entry is (are) satisfied. If the condition(s) is (are) not satisfied, then the inline authentication and authorization engine 112 does not authorize the command. However, if the condition(s) is (are) satisfied, then the inline authentication and authorization engine 112 authorizes the command.

If the command is not authorized, the inline authentication and authorization engine 112 discards (at 212) the command, and the command is not allowed to be executed. In some examples, the inline authentication and authorization engine 112 may also send an indication to the client device 102 that the command is not authorized.

However, if the command is authorized by the command enforcement policy, the intermediary device 106 forwards (at 214) the command to the server system 104. At the server system 104, the server system 104 executes (at 216) the command to perform a task according to the command.

By performing the authentication and authorization tasks at the intermediary device 106, the intermediary device 106 would not have to interact with a remote system to perform the authentication and authorization tasks. For example, the intermediary device 106 would not have to perform encryption and decryption of AA-related messages that would otherwise be performed in communications between the intermediary device 106 and the remote system. Also, not communicating AA-related messages outside the intermediary device 106 avoids exposing the AA-related messages to external attackers. Additionally, if the intermediary device 106 is implemented in a cloud computing environment, an enterprise would not have to maintain on-premises equipment to support the inline authentication and authorization tasks.

Additionally, the command enforcement policy information 124 can be dynamically updated over time, such as by an administrator or another entity. For example, as new commands are added or commands are modified, and as conditions under which commands are allowed are changed, the command enforcement policy information 124 can be updated accordingly. This increases flexibility in how commands are authorized.

In some examples, the inline authentication and authorization engine 112 can add information of each processed command (whether allowed or discarded) to the audit log 128 (FIG. 1).

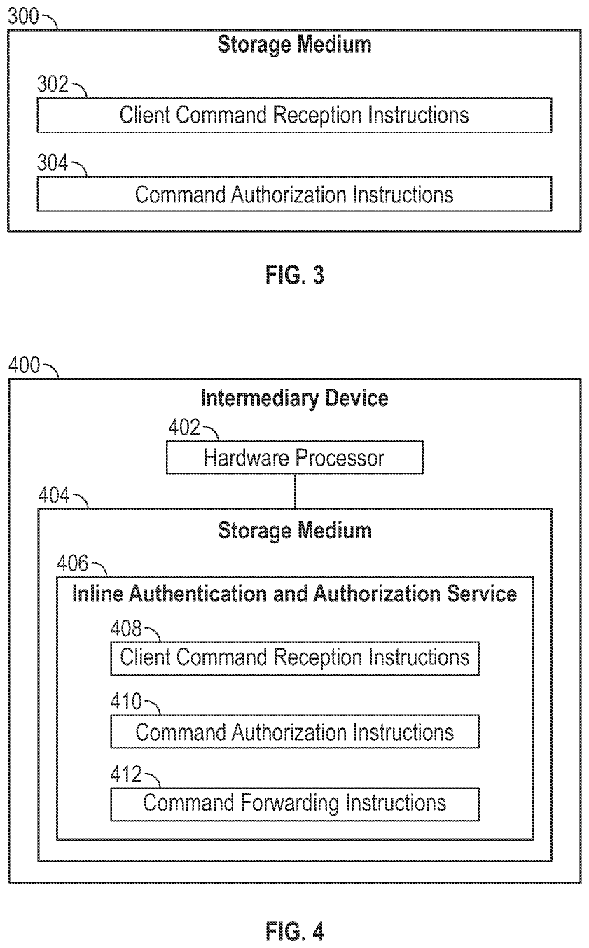

FIG. 3 is a block diagram of a non-transitory machine-readable or computer-readable storage medium 300 storing machine-readable instructions that upon execution cause an intermediary device to perform various tasks. An example of the intermediary device is the intermediary device 106 of FIG. 1.

The machine-readable instructions include client command reception instructions 302 to receive, at the intermediary device from a client device, a command associated with a secure protocol that secures a connection between the client device and a server system. The intermediary device includes an inline authentication and authorization service between the client device and the server system. For example, the inline authentication and authorization service is a service executed by the inline authentication and authorization engine 112 of FIG. 1. An example of the secure protocol is the SSH protocol, which secures communications (based on application of encryption) of messages between a client device and a server system, and which provides for communications of commands to a remote entity such as the server system, where the commands can control features of the server system.

The machine-readable instructions include command authorization instructions 304 to determine, by the inline authentication and authorization service at the intermediary device based on command enforcement policy information (e.g., 124 in FIG. 1), whether to authorize the command received from the client device. The command enforcement policy information can include entries containing conditions under which respective commands are allowed (or disallowed).

In some examples, the command received at the intermediary device from the client device is in an encrypted form. The machine-readable instructions can decrypt the command to produce a decrypted command, and the authorizing is performed with respect to the decrypted command. Based on the authorizing of the decrypted command, the machine-readable instructions can re-encrypt the decrypted command to produce an encrypted command, and the machine-readable instructions can cause sending of the encrypted command from the intermediary device to the server system.

In some examples, the machine-readable instructions can establish a first session between the intermediary device and the client device, where the command in the encrypted form is received from the client device in the first session. The machine-readable instructions can allow or deny establishment of a second session to between the intermediary device and the server system, where the sending of the encrypted command from the intermediary device to the server system occurs in the second session.

In some examples, the inline authentication and authorization service can authenticate the client device using a certificate of the client device. In some examples, the authenticating of the client device and the authorizing of the command are performed without any involvement of the server system.

In some examples, the intermediary device is in a cloud computing environment.

In some examples, the machine-readable instructions can update an audit log (e.g., 128 in FIG. 1) by adding information relating to the command to the audit log. The audit log includes information of commands processed at the inline authentication and authorization service in the intermediary device.

In some examples, the conditions specified by the command enforcement policy information can include a condition based on ownership information indicating an owner or manager of the client device (e.g., the client device is owned or managed by an enterprise).

In some examples, the conditions specified by the command enforcement policy information can include a condition based on information of a malware protection program of the client device.

In some examples, the conditions specified by the command enforcement policy information can include a condition based on a rate of commands received from the client device.

In some examples, the conditions specified by the command enforcement policy information can include a condition based on a quantity of server systems to which the client device is connected.

FIG. 4 is a block diagram of an intermediary device 400 according to some examples. The intermediary device 400 includes a hardware processor 402 (or multiple hardware processors). A hardware processor can include a microprocessor, a core of a multi-core microprocessor, a microcontroller, a programmable integrated circuit, a programmable gate array, or another hardware processing circuit.

The intermediary device 400 includes a storage medium 404 storing machine-readable instructions of an inline authentication and authorization service 406 executable on the hardware processor to perform various tasks. The inline authentication and authorization service 406 is provided between the client device and the server system. Machine-readable instructions executable on a hardware processor can refer to the instructions executable on a single hardware processor or the instructions executable on multiple hardware processors.

The machine-readable instructions in the storage medium 404 include client command reception instructions 408 to receive, at the inline authentication and authorization service 406 from a client device, a command to control a feature of a server system. The command may be according to a secure protocol such as the SSH protocol, for example.

The machine-readable instructions in the storage medium 404 include command authorization instructions 410 to determine, by the inline authentication and authorization service 406 according to command enforcement policy information, whether to authorize the command received from the client device. The command enforcement policy information can include entries containing conditions under which respective commands are allowed (or disallowed).

The machine-readable instructions include command forwarding instructions 412 to, based on determining that the command is authorized according to the command enforcement policy information, cause sending, from the intermediary device 400, of the command to the server system for execution at the server system.

In some examples, the intermediary device 400 behaves as a server to the client device, and the intermediary device behaves as a client to the server system.

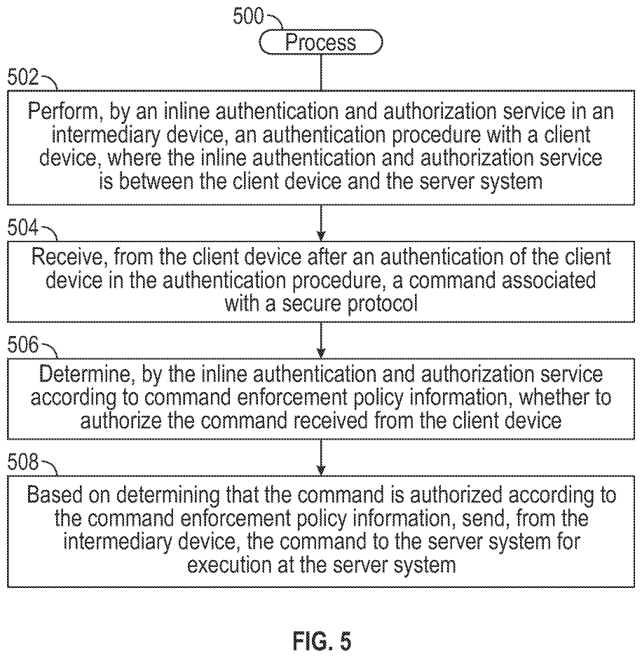

FIG. 5 is a flow diagram of a process 500 according to some examples. The process 500 may be performed by an intermediary device (e.g., 106 in FIG. 1).

The process 500 includes performing (at 502), by an inline authentication and authorization service in the intermediary device, an authentication procedure with the client device, where the inline authentication and authorization service is between the client device and a server system. The authentication procedure may be triggered by an authentication request, such as from the client device.

The process 500 includes receiving (at 504), from the client device after an authentication of the client device in the authentication procedure, a command associated with a secure protocol. The secure protocol may be the SSH protocol in some examples.

The process 500 includes determining (at 506), by the inline

authentication and authorization service according to command enforcement policy information, whether to authorize the command received from the client device.

Based on determining that the command is authorized according to the command enforcement policy information, the process 500 includes sending (at 508), from the intermediary device, the command to the server system for execution at the server system.

A storage medium (e.g., 300 in FIG. 3 or 404 in FIG. 4) can include any or some combination of the following: a semiconductor memory device such as a DRAM or SRAM, an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause an intermediary device to:
receive, at the intermediary device from a client device, a command associated with a secure protocol that secures a connection between the client device and a server system, wherein the intermediary device comprises an inline authentication and authorization service between the client device and the server system; and
determine, by the inline authentication and authorization service at the intermediary device based on command enforcement policy information, whether to authorize the command received from the client device.

2. The non-transitory machine-readable storage medium of claim 1, wherein the server system comprises a network access device that provides access to a network by the client device.

3. The non-transitory machine-readable storage medium of claim 1, wherein the secure protocol comprises a Secure Shell (SSH) protocol, and the command is associated with the SSH protocol.

4. The non-transitory machine-readable storage medium of claim 1, wherein the command is to control a feature of the server system, and the command is protected by the secure protocol.

5. The non-transitory machine-readable storage medium of claim 1, wherein the command received at the intermediary device from the client device is in an encrypted form, and wherein the instructions upon execution cause the intermediary device to:
decrypt the command to produce a decrypted command, wherein the authorizing is performed with respect to the decrypted command; and
based on the authorizing of the decrypted command, re-encrypt the decrypted command to produce an encrypted command; and
cause sending of the encrypted command from the intermediary device to the server system.

6. The non-transitory machine-readable storage medium of claim 5, wherein the instructions upon execution cause the intermediary device to:
establish a first session between the intermediary device and the client device, wherein the command in the encrypted form is received from the client device in the first session; and
establish a second session between the intermediary device and the server system, wherein the sending of the encrypted command from the intermediary device to the server system occurs in the second session.

7. The non-transitory machine-readable storage medium of claim 1, wherein the instructions upon execution cause the intermediary device to:
authenticate, by the inline authentication and authorization service, the client device using a certificate of the client device.

8. The non-transitory machine-readable storage medium of claim 7, wherein the authenticating of the client device and the authorizing of the command are performed without any involvement of the server system.

9. The non-transitory machine-readable storage medium of claim 1, wherein the intermediary device is in a cloud computing environment.

10. The non-transitory machine-readable storage medium of claim 1, wherein the instructions upon execution cause the intermediary device to:
update an audit log by adding information relating to the command to the audit log, wherein the audit log comprises information of commands processed at the inline authentication and authorization service in the intermediary device.

11. The non-transitory machine-readable storage medium of claim 1, wherein the command enforcement policy information specifies one or more conditions under which respective commands are allowed.

12. The non-transitory machine-readable storage medium of claim 11, wherein the one or more conditions comprise a condition based on ownership information indicating an owner or manager of the client device.

13. The non-transitory machine-readable storage medium of claim 11, wherein the one or more conditions comprise a condition based on information of a malware protection program of the client device.

14. The non-transitory machine-readable storage medium of claim 11, wherein the one or more conditions comprise a condition based on a rate of commands received from the client device.

15. The non-transitory machine-readable storage medium of claim 11, wherein the one or more conditions comprise a condition based on a quantity of server systems to which the client device is connected.

16. An intermediary device comprising:
a hardware processor; and
a non-transitory storage medium comprising instructions of an inline authentication and authorization service executable on the hardware processor to:
receive, at the inline authentication and authorization service from a client device, a command to control a feature of a server system, wherein the inline authentication and authorization service is provided between the client device and the server system;
determine, by the inline authentication and authorization service at the intermediary device according to command enforcement policy information, whether to authorize the command received from the client device; and
based on determining that the command is authorized according to the command enforcement policy information, cause sending, from the intermediary device, of the command to the server system for execution at the server system.

17. The intermediary device of claim 16, wherein the intermediary device behaves as a server to the client device, and the intermediary device behaves as a client to the server system.

18. The intermediary device of claim 16, wherein the instructions are executable on the hardware processor to:
receive, at the inline authentication and authorization service from a client device, an authentication request; and
based on receiving the authentication request, perform an authentication procedure between the client device and the intermediary device to authenticate the client device,
wherein the command from the client device is transmitted by the client device after the authenticating of the client device.

19. A method comprising:
performing, by an inline authentication and authorization service in an intermediary device, an authentication procedure with a client device, wherein the inline authentication and authorization service is between the client device and a server system;
receiving, from the client device after an authentication of the client device in the authentication procedure, a command associated with a secure protocol;
determining, by the inline authentication and authorization service according to command enforcement policy information, whether to authorize the command received from the client device; and
based on determining that the command is authorized according to the command enforcement policy information, sending, from the intermediary device, the command to the server system for execution at the server system.

20. The method of claim 19, wherein the command is an administrative command to control a feature of the server system.
